(19) United States
(12) Patent Application Publication
(10) Pub. No.: US 2016/0009233 A1
(43) Pub. Date: Jan. 14, 2016

(54) FLOATING IMAGE LAMP

(71) Applicant: GM Global Technology Operations LLC, Detroit, MI (US)

(72) Inventor: Richard E. Lund, WARREN, MI (US)

(21) Appl. No.: 14/329,124

(22) Filed: Jul. 11, 2014

(51) Int. Cl. B60R 13/00; B60Q 3/02; F21S 8/10

(52) U.S. Cl. CPC B60R 13/00; F21S 48/24; F21S 48/25; B60Q 3/0279; F21W 2101/14

(57) ABSTRACT

A number of variations may include a lamp which includes a light source and first and second parabolic mirrored surfaces which extend radially from either side of the light source. A clear lens may be disposed directly above the light source and may be operably coupled to both the first and second parabolic mirrored surfaces. Moreover, an object may be disposed on top of the light source and when the light source is turned on a floating 3-dimensional image may be produced.

### TECHNICAL FIELD

The field to which the disclosure generally relates to includes lighting, and specifically vehicle interior and exterior lighting.

### BACKGROUND

Vehicles include various lights designed for function and style.

### SUMMARY OF ILLUSTRATIVE VARIATIONS

A number of variations may include a lamp which comprises a light source and a first and second parabolic mirrored surface extending radially from either side of the light source. The lamp also may include a clear lens which may be disposed directly above the light source and may be operably coupled to both the first and second parabolic mirrored surfaces. Moreover, an object may be disposed on top of the light source. When the light source is turned on, a floating 3-dimensional image of the object may be produced.

A number of other variations may include a lamp including a light source wherein the light source may be a light pipe. Additionally, a first and second parabolic mirrored surface may extend radially from either side of the light pipe. Moreover, an object may be disposed on top of the light pipe. When the light pipe is turned to the on position, a floating 3-dimensional image of the object may be produced.

Yet another variation may include a method comprising the steps of providing a light source operably coupled to a first parabolic mirrored surface and a second parabolic mirrored surface in a clear lens disposed above the light source. Next, an object may be placed on top of the light source. The light source may then be turned on. A floating 3-dimensional image of the object may be projected to a user which is visible from 360 degrees.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a side perspective view of a floating image lamp according to a number of variations;

FIG. 2 is a side perspective view of the floating image lamp shown in FIG. 1, having a light source turned on;

FIG. 3 is a front perspective view of a cross-section of the lamp;

FIG. 4 is a side plan view of a cross-section of the lamp;

FIG. 5 is a rear plan view according to a number of variations of the lamp;

FIG. 6 is a side plan view according to a number of variations of the lamp;

FIG. 7 is a side perspective view according to a number of variations of the lamp;

FIG. 8 is another side perspective view of the floating lamp.

### DETAILED DESCRIPTION OF ILLUSTRATIVE VARIATIONS

The following description of the variations is merely illustrative in nature and is in no way intended to limit the scope of the invention, its application, or uses.

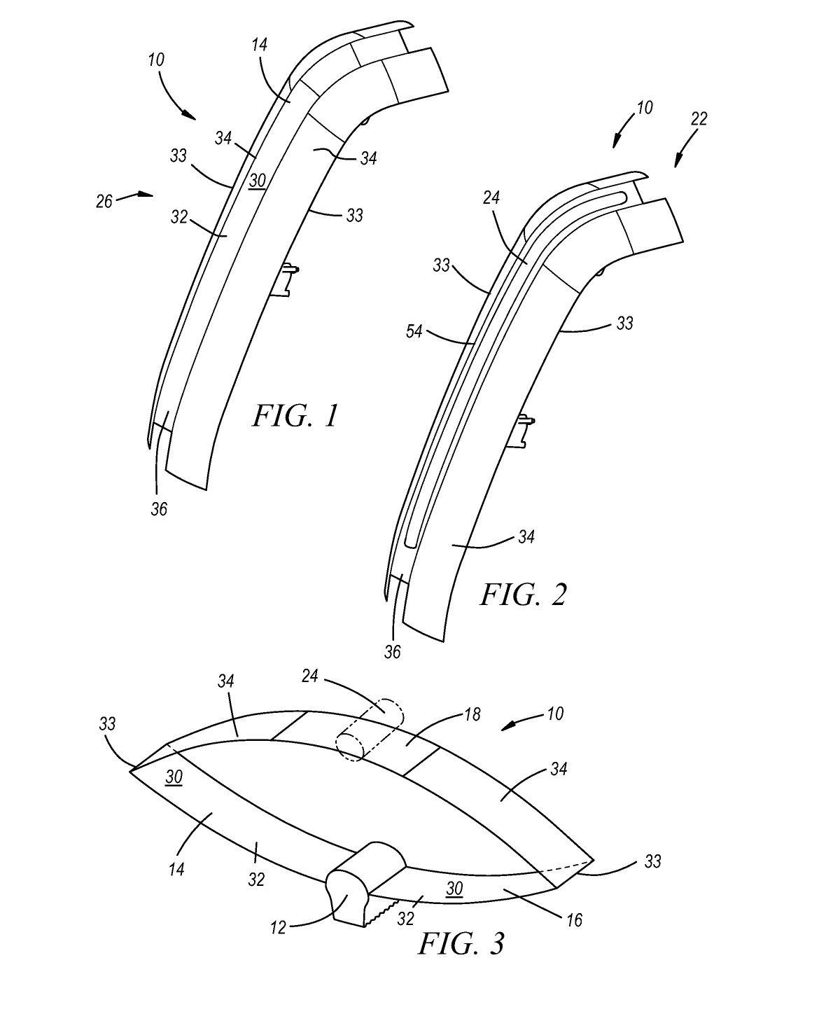

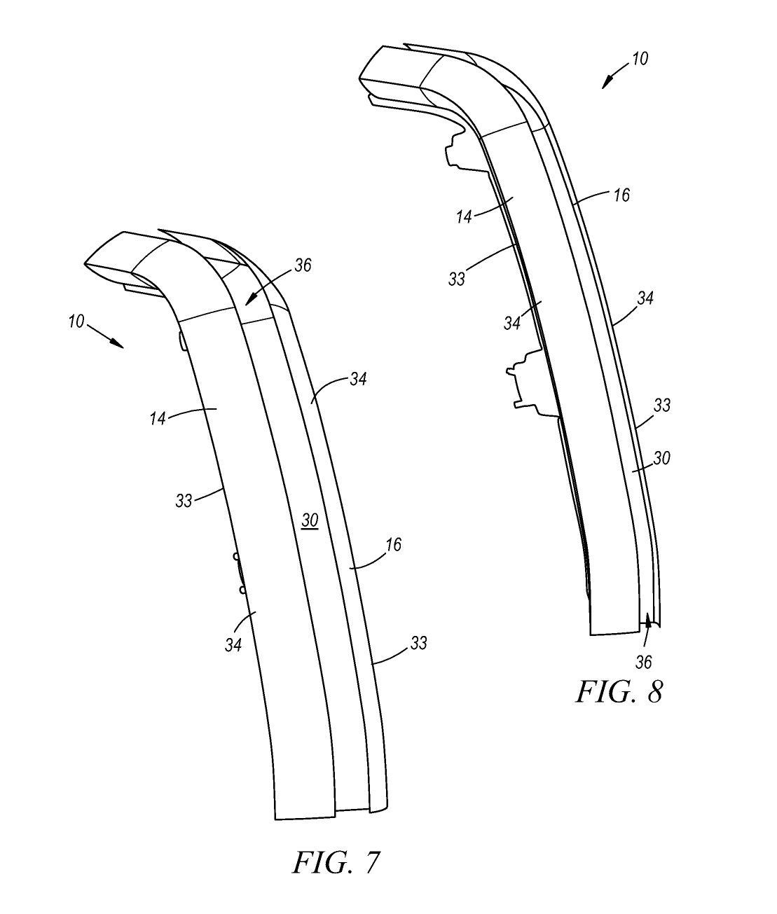

FIGS. 1-8 generally show a lamp 10 which includes a light source 12 and a first and second parabolic mirrored surface 14, 16 extending radially from either side of the light source 12. A clear lens 18 is disposed directly above the light source 12 and is operably coupled to both the first and second parabolic mirrored surfaces 14, 16. Additionally, an object 20 is disposed on top of the light source 12 and when the light source 12 is turned on, a floating 3-dimensional image 24 of the object 20 is produced.

As shown in FIG. 1, the light source 12 may be a light pipe which is disposed in a taillight lamp of an automotive vehicle. It is also contemplated that the light source 12 may be any other light source such as a conventional light bulb, an LED light, a fluorescent light, or any other light as known by one of ordinary skill in the art. Additionally, the light source 12 may be placed in any part of an automotive vehicle including any portion of the interior or exterior. It is also contemplated that the floating image lamp 10 of the present invention could be used in other applications in order to increase stylized design.

The light source 12 may be a single light bulb or a tube-like structure as shown in FIGS. 1 and 2. The light source 12 may be turned on 22 and off 26 either by a user operated system, or an automated system controlled by a controller of the vehicle. The turning on 22 of the light source may also be triggered by an event such as a vehicle door opening or closing, or brakes of the vehicle being activated.

As shown in the variation illustrated in FIGS. 1 and 2, when the light source 12 is off 26, no image may be visible, as illustrated in FIG. 1. However, when the light source 12 is turned on 22, as illustrated in FIG. 2, the floating image 24 becomes visible to a user.

As illustrated in the variation shown in FIG. 3, the first parabolic mirrored surface 14 and the second parabolic mirrored surface 16 extend radially in opposite directions from the light source 12. The first and second parabolic mirrored surfaces 14, 16 may be comprised of any mirrored material. It is also contemplated that the first and second parabolic mirrored surfaces 14, 16 would be comprised of a general steel component having a mirrored portion 30 affixed to an inside surface. As illustrated in the variation shown in FIG. 3, the first and second parabolic mirrored surfaces 14, 16 may generally extend in a curved or concave direction forming a bottom parabolic section 32. Once the first and second parabolic mirrored surfaces 14, 16 reach a certain length, the first and second parabolic mirrored surfaces 14, 16 bend and form a corner 33. The first and second parabolic mirrored surfaces 14, 16 continue to extend and then form a generally convex parabolic top section 34. The first and second parabolic mirrored surfaces 14, 16 generally form a spheroid having pointed ends. FIG. 3 generally shows the cross section of the lamp as a prolate spheroid having pointed and not rounded ends and may be generally in the shape of an American football.

As illustrated in variations shown in FIG. 3, the top section 34 of the first and second parabolic mirrored surfaces 14, 16 meet on either side of the clear lens 18. The clear lens maybe comprised of any clear material as known by one of ordinary skill in the art, including but not limited to plastic, glass and acrylic. The clear lens 18 may be generally disposed directly above the light source 12 and may also be operably coupled to both the first and second parabolic mirrored surfaces 14, 16. It is also contemplated that the clear lens 18 may be absent from the lamp 10 and the space between the first and second parabolic mirrored surfaces 14, 16 may be an aperture 36.

The clear lens 18 or aperture 36 may have a length and width configured to extend the entire distance between the first and second parabolic mirrored surfaces 14, 16. Moreover, the clear lens 18 or aperture 36 may be generally rectangular and generally has a length and width larger than the object 20. However, it is also contemplated that the clear lens 18 or aperture 36 may be of any other size and shape as known by one of ordinary skill in the art. When the light source 12 is turned on 22 the floating image 24 is then disposed or projected above the clear lens 18 or aperture 36 where the floating image 24 may be visible from 360 degrees to a user. It is also contemplated that the light source 12 and/or the clear lens 18 may be colored such that when the object 20 is placed on the light source 12 the produced image 24 of the object 20 may include increased or changed color patterns in order to produce a more stylized design.

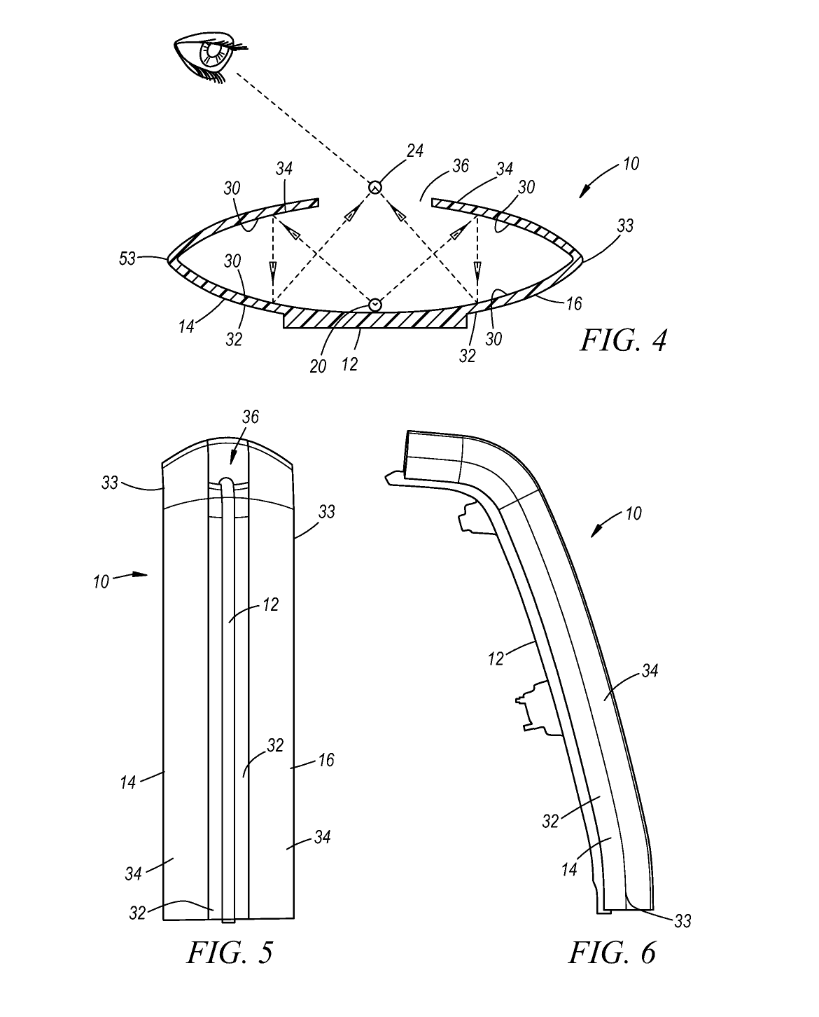

Referring now to FIG. 4, in operation, the object 20 may be placed on the light source 12. When the light source 12 is turned on 22 the object 20 may be reflected onto the top parabolic section 34 of the first parabolic mirrored surface 14 and the top parabolic section 34 of the second parabolic mirrored surface 16. The light is then reflected onto the bottom parabolic section 32 of the first parabolic mirrored section 14 and the bottom parabolic section 32 of the second parabolic mirrored section 16. The images from the bottom parabolic section 32 of the first and second parabolic sections 14, 16 converge to create one 3-dimensional virtual image 24 which may be displayed directly above the light source 12 and directly above either the clear lens 18 or the aperture 36 between the first and second parabolic mirrored sections 14, 16. When an observer looks into the opening 36 or at the clear lens 18, the user may observe a floating virtual image 24 of the object 20 placed on the light source 12 below.

Additionally, when the light source 12 is turned off 26, the floating image 24 may not be visible. Moreover, when the light source 12 is off 26, the light source 12 may not be visible to the user. This provides a more stylized design to the user whether the light source 12 is on 22 or off 26. It is also contemplated that when the light source 12 is off 26, the image 24 may still be visible to the user. The image 24 that may appear when the light source 12 is off 26 may be dim or in a different color pattern than the original object 20. The image 24 is instantly produced when the light source 12 is turned on 22 or when the object 20 is placed on the light source 12, according to different variations.

Referring now to the variations illustrated in FIGS. 5-8, as described above, the floating lamp 10 of the present invention may be incorporated into one or more locations of various objects including but not limited to a vehicle interior including the dashboard or other interior features or the vehicle exterior including the vehicle taillight or vehicle emblem. The floating image 24 may be produced to the user as appearing to be a truly solid object in full color which produces an essential hologram having a natural and lifelike appearance.

FIGS. 6-8 show a variation where the light source 12 may be curved in order to provide a more stylized design. In a variation illustrated in FIGS. 6-8, the lamp 10 may still have the first and second parabolic surfaces which form the double parabolic cross-section in order to produce the floating image 24 similar to as described in the variation shown in FIG. 4.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

The present invention provides a more stylized design to a vehicle and provides pleasing esthetics to a user.

Variation 1 may include a lamp which includes a light source and first and second parabolic mirrored surface extending radially from either side of the light source. Moreover, a clear lens may be disposed directly above the light source and may be operably coupled to both the first and second parabolic mirrored surfaces. Additionally, an object may be disposed on top of the light source and when the light source is turned on a floating 3-dimensional image of the object is produced.

Variation 2 may include a lamp as set forth in variation 1 wherein the light source is a light pipe.

Variation 3 may include a lamp as set forth in any of variations 1-2 wherein the lamp is a generally double parabolic cross-section.

Variation 4 may include a lamp as set forth in any of variations 1-3 wherein the floating image is viewable from 360 degrees.

Variation 5 may include a lamp as set forth in any of variations 1-4 wherein the first parabolic mirrored surface and the second parabolic mirrored surface form an aperture which is disposed directly above the light source.

Variation 6 may include a lamp according to any of variations 1-5 wherein the floating image is produced in a vehicle interior.

Variation 7 may include a lamp as set forth in any of variations 1-6 wherein the floating image is produced on a vehicle exterior.

Variation 8 may include a lamp as set forth in any of variations 1-7 wherein the floating image is produced on a vehicle taillight.

Variation 9 may include a lamp which may include a light source wherein the light source is a light pipe. Additionally, the lamp may include a first and second parabolic mirrored surface which extends radially from either side of the light pipe. An object may be disposed on top of the light pipe and when the light pipe is in an on position, a floating 3-dimensional image of the object is produced.

Variation 10 may include a lamp as set forth in variation 9 wherein the lamp has a generally double parabolic cross-section.

Variation 11 may include a lamp as set forth in any of variations 9-10 wherein the floating image is viewable for 360 degrees.

Variation 12 may include a lamp as set forth in any of variations 9-11 wherein the first parabolic mirrored surface and the second parabolic mirrored surface form an aperture disposed directly above the light pipe.

Variation 13 may include a lamp as set forth in any of variations 9-12 wherein the floating image is produced in a vehicle interior.

Variation 14 may include a lamp as set forth in any of variations 9-13 wherein the floating image is produced on a vehicle exterior.

Variation 15 may include a lamp as set forth in any of variations 9-14 wherein the floating image is produced on a vehicle taillight.

Variation 16 may include a method which includes first providing a light source which is operably coupled to a first parabolic mirrored surface and a second parabolic mirrored surface. A clear lens is disposed above the light source. Next an object is placed on top of the light source and then the light source is turned on. When the light source is turned on a floating 3-dimensional image of the object which is visible from 360 degrees is projected to the user.

Variation 17 may include a method as set forth in variation 16 wherein the light source is a light pipe.

Variation 18 may include a method as set forth in any of variations 16-17 further including the step of producing the image inside of a vehicle interior.

Variation 19 may include a method as set forth in any of variations 16-18 further including the step of producing the image on a vehicle exterior.

Variation 20 may include a method as set forth in any of variations 16-19 further including the step of producing the image on a vehicle taillight.

The above description of select variations within the scope of the invention is merely illustrative in nature and, thus, variations or variants thereof are not to be regarded as a departure from the spirit and scope of the invention.

What is claimed is:

1. A lamp comprising:
a light source;
a first and second parabolic mirrored surface extending radially from either side of the light source;
a clear lens disposed directly above the light source and operably coupled to both the first and second parabolic mirrored surfaces; and
an object disposed on top of the light source, wherein when the light source is turned on a floating 3-dimensional image of the object is produced.

2. The lamp of claim 1, wherein the light source is a light pipe.

3. The lamp of claim 1, wherein the lamp has a generally double parabolic cross-section.

4. The lamp of claim 1, wherein the floating image is viewable from 360 degrees.

5. The lamp of claim 1, wherein the first parabolic mirrored surface and the second parabolic mirrored surface form an aperture disposed directly above the light source.

6. The lamp of claim 1, wherein the floating image is produced in a vehicle interior.

7. The lamp of claim 1, wherein the floating image is produced on a vehicle exterior.

8. The lamp of claim 7, wherein the floating image is produced on a vehicle taillight.

9. A lamp comprising:
a light source, wherein the light source is a light pipe;
a first and second parabolic mirrored surface extending radially from either side of the light pipe; and
an object disposed on top of the light pipe, wherein when the light pipe is in an on position a floating 3-dimensional image of the object is produced.

10. The lamp of claim 9, wherein the lamp has a generally double parabolic cross-section.

11. The lamp of claim 9, wherein the floating image is viewable from 360 degrees.

12. The lamp of claim 9, wherein the first parabolic mirrored surface and the second parabolic mirrored surface form an aperture disposed directly above the light pipe.

13. The lamp of claim 9, wherein the floating image is produced in a vehicle interior.

14. The lamp of claim 9, wherein the floating image is produced on a vehicle exterior.

15. The lamp of claim 14, wherein the floating image is produced on a vehicle taillight.

16. A method comprising the steps of:
providing a light source operably coupled to a first parabolic mirrored surface and a second parabolic mirrored surface and a clear lens disposed above the light source;
placing an object on top of the light source;
turning on the light source; and
projecting a floating, 3-dimensional image of the object which is visible from 360 degrees.

17. The method of claim 16 wherein the light source is a light pipe.

18. The method of claim 16 further comprising the step of producing the image in a vehicle interior.

19. The method of claim 16 further comprising the step of producing the image on a vehicle exterior.

20. The method of claim 16 further comprising the step of producing the image on a vehicle taillight.
